(19) United States
(12) Patent Application Publication
(10) Pub. No.: US 2021/0140849 A1
(43) Pub. Date: May 13, 2021

(54) CONDITION MONITORING DEVICE, WIND TURBINE EQUIPPED WITH THE SAME, AND METHOD FOR REMOVING ELECTRICAL NOISE

(71) Applicant: NTN CORPORATION, Osaka-shi, Osaka (JP)

(72) Inventors: Hideyuki TSUTSUI, Kuwana-shi, Mie (JP); Kouma KATOU, Kuwana-shi, Mie (JP)

(73) Assignee: NTN CORPORATION, Osaka-shi, Osaka (JP)

(21) Appl. No.: 16/087,336

(22) PCT Filed: Mar. 6, 2017
(86) PCT No.: PCT/JP2017/008786

§ 371 Date: Sep. 21, 2018

(30) Foreign Application Priority Data
Mar. 22, 2016 (JP) 2016-057126

(51) Int. Cl. G01M 13/045; F03D 17/00

(52) U.S. Cl. CPC G01M 13/045; F03D 17/00

(57) ABSTRACT

A condition monitoring device determines whether abnormality has occurred to a bearing included in a rolling device. The condition monitoring device includes a condition monitoring sensor for detecting vibration of a bearing, a reference sensor, and a controller configured to determine whether abnormality has occurred to the bearing. The reference sensor is electrically non-insulated from the condition monitoring sensor, and disposed at a location less influenced by vibration generated when abnormality occurs to the bearing under monitoring. The controller is configured to identify a period during which electrical noise is generated, based on a detected value of the reference sensor, generate determination data by removing data for the period during which the electrical noise is generated, from the vibration data of the condition monitoring sensor, and determine whether or not abnormality has occurred to the bearing under monitoring, using the determination data.

### TECHNICAL FIELD

The present invention relates to a condition monitoring device for a rolling device and to a wind turbine equipped with the condition monitoring device, and particularly relates to a technique for removing electrical noise of a sensor during an abnormality monitoring of a rolling device.

### BACKGROUND ART

Abnormality occurring to a bearing of a rolling device which includes bearings may cause a rotating member to become unable to rotate normally, or cause devices to be damaged due to increase of generated heat and/or vibration. Particularly as to a wind turbine, a large-sized rotating member is disposed at a high level, and therefore, unless abnormality is detected appropriately and addressed immediately, devices may be damaged, possibly resulting in an enormous repair cost, for example.

Japanese Patent Laying-Open Nos. 2006-105956 (PTL 1) and 2006-234785 (PTL 2) each disclose an abnormality diagnosis device for a rolling bearing. This abnormality diagnosis device conducts a frequency analysis for an electrical signal from a vibration sensor to extract peaks of a spectrum higher than a reference value calculated based on a spectrum acquired through the frequency analysis. Then, the frequency between peaks is compared with a frequency component resultant from damage. The frequency component is calculated based on a rotational speed. Based on the result of the comparison, it is determined whether or not abnormality has occurred to the rolling bearing and an abnormal part is identified (see PTL 1 and PTL 2).

### CITATION LIST

### Patent Literature

PTL 1: Japanese Patent Laying-Open No. 2006-105956
PTL 2: Japanese Patent Laying-Open No. 2006-234785

### SUMMARY OF INVENTION

### Technical Problem

In a large-scale plant facility such as wind turbine, generally a plurality of sensors are used to monitor the condition of the facility. Outputs of these sensors are received through I/O of a monitoring device. Respective electrical signals from the sensors are generally input by means of a common input/output power supply. Therefore, the sensors are not electrically insulated from each other in most cases.

Data detected by these sensors may include electrical noise which interferes with condition monitoring. The electrical noise is caused by transmitted radio waves for television or radio receivers, radio signals for communication devices, or electromagnetic field leakage from other peripheral devices, for example. If such electrical noise is present in detected data, the noise may be determined erroneously to be abnormality during condition monitoring.

In order to prevent such erroneous determination resultant from electrical noise, above-referenced PTL 1 for example employs a system in which a band-pass filter is applied to a sensor-detected signal to extract only the data in a frequency band that can be generated due to abnormality.

In a system according to PTL 2, when an abnormal part can be identified as a rolling bearing, attention is focused on only a frequency band that can be generated due to abnormality and calculated in advance from the design specification for the bearing, so as to eliminate influences of noise in other frequency bands.

If, however, the abnormal part cannot be identified or information on the specification of the bearing is unavailable, the frequency band to be focused on (frequency band to be extracted) cannot be specified in some cases. Moreover, if the frequency of electrical noise overlaps a frequency band of vibration generated when abnormality occurs to an object to be measured, or the frequency of electrical noise is in close proximity to the frequency band of vibration, noise cannot be separated appropriately by the approaches disclosed in the above-referenced patent documents, possibly resulting in erroneous determination of abnormality.

The present invention has been made to solve such a problem, and an object of the present invention is to remove electrical noise generated in a condition monitoring sensor, without the need to exclude a specific frequency band, so as to reduce errors in determination of abnormality.

### Solution to Problem

A condition monitoring device according to an aspect of the present invention is a condition monitoring device for a rolling device including a first bearing. The condition monitoring device includes: a monitoring vibration sensor configured to detect vibration of the first bearing; a reference vibration sensor; and a controller. The reference vibration sensor is electrically non-insulated from the monitoring vibration sensor and disposed at a location less influenced by vibration generated in occurrence of abnormality in the first bearing. The controller is configured to monitor abnormality of the first bearing based on vibration data detected by the monitoring vibration sensor. The controller is configured to (a) identify a generation period of electrical noise based on a detected value of the reference vibration sensor, (b) generate determination data by removing data for the generation period of electrical noise from the vibration data of the monitoring vibration sensor, and (c) determine occurrence of abnormality in the first bearing, using the determination data.

According to this configuration, the controller selects, as a reference vibration sensor, a vibration sensor which is electrically non-insulated from the monitoring vibration sensor configured to monitor the condition of a bearing under monitoring, and which is disposed at a location less influenced by abnormality occurring to the bearing under monitoring. Based on vibration data (vibration waveform) of the reference vibration sensor, the controller identifies a generation period of electrical noise. Because the reference vibration sensor is electrically non-insulated from the monitoring vibration sensor, the electrical noise which occurs to the reference vibration sensor may also occur to the monitoring vibration sensor. The controller generates determination data by removing, from vibration data of the monitoring vibration sensor, data for the generation period of electrical noise identified based on the waveform of the reference vibration sensor. The controller determines occurrence of abnormality, using the generated determination data. In this way, occurrence of abnormality can be determined using only the data having no influence of the electrical noise, without excluding data in a specific frequency band. Thus, error in determination due to electrical noise can be suppressed.

Preferably, the reference vibration sensor is disposed at a location where a vibration level is less than or equal to 2 m/s² in a state where no abnormality occurs to the first bearing.

According to this configuration, the reference vibration sensor can be disposed at a location where the vibration level is low, and therefore, influence of vibration caused by a failure of another bearing can be reduced.

Preferably, the rolling device further includes a second bearing, and the reference vibration sensor is a sensor configured to detect vibration of the second bearing.

According to this configuration, one of the monitoring vibration sensors can be used as a reference vibration sensor, and therefore, increase of the number of parts and increase of the cost can be suppressed.

Preferably, the controller is configured to (1) generate calculation data by subtracting, from vibration data of the reference vibration sensor detected for a predetermined period, an average value of the vibration data for the predetermined period, (2) divide the calculation data into N segments at predetermined time intervals, (3) generate (N−M+1) group segments from the N segments, each of the group segments being made up of any M (M<N) consecutive segments in the N segments, (4) determine calculation data included in a group segment and having a maximum absolute value among calculation data included in respective group segments, (5) calculate respective RMS values of the calculation data of respective segments and calculate an average RMS value by averaging respective RMS values of p (p<M) pieces of data in ascending order from a piece of data having a smallest RMS value, (6) identify a group segment having the maximum absolute value at least 10 times as large as the average RMS value, as a noise-generated segment including influence of electrical noise, and (7) generate the determination data by removing, from vibration data of the reference vibration sensor, data for a period corresponding to the noise-generated segment.

According to this configuration, occurrence of abnormality can be determined using data from which electrical noise has been removed appropriately, and therefore, erroneous determination in abnormality detection can be suppressed.

A condition monitoring device according to another aspect of the present invention is a condition monitoring device for a rolling device including a plurality of bearings. The condition monitoring device includes: a plurality of vibration sensors each provided for a corresponding bearing among the plurality of bearings, the plurality of vibration sensors each being configured to detect vibration of the corresponding bearing; and a controller configured to monitor abnormality of the plurality of bearings based on respective vibration data detected by the plurality of vibration sensors. The plurality of vibration sensors are electrically non-insulated from each other. The controller is configured to (a) select one of the plurality of vibration sensors as a reference vibration sensor, and identify a generation period of electrical noise based on a detected value of the reference vibration sensor, (b) generate, for each vibration sensor of the plurality of vibration sensors, determination data by removing data for the generation period of electrical noise from vibration data detected by the each vibration sensor, and (c) determine occurrence of abnormality in the bearing for which the each vibration sensor is provided, using the determination data.

According to this configuration, one of the monitoring vibration sensors can be used as a reference vibration sensor, and therefore, increase of the number of parts and increase of the cost can be suppressed. Moreover, occurrence of abnormality can be determined using only data having no influence of electrical noise, without the need to exclude data in a specific frequency band, and therefore, erroneous determination due to electrical noise can be suppressed.

Preferably, the controller is configured to calculate, for each of the plurality of vibration sensors, a rate of change of an RMS value of the detected vibration data in an abnormal state with respect to an RMS value of the detected vibration data in a normal state. The controller is configured to select, as the reference vibration sensor, a vibration sensor having the rate of change of the RMS value less than or equal to one tenth of the rate of change of the RMS value of a vibration sensor for a bearing to which abnormality occurs.

According to this configuration, a sensor appropriate for use as a reference vibration sensor can be selected from the monitoring vibration sensors.

A wind turbine according to still another aspect of the present invention includes a condition monitoring device according to any of the foregoing.

A method according to a further aspect of the present invention is a method for removing electrical noise from a monitoring vibration sensor of a condition monitoring device for a rolling device including a bearing. The condition monitoring device includes the monitoring vibration sensor configured to detect vibration of the bearing. The condition monitoring device further includes a reference vibration sensor electrically non-insulated from the monitoring vibration sensor and less influenced by vibration generated in occurrence of abnormality in the bearing. The method includes: (a) identifying a generation period of the electrical noise based on a detected value of the reference vibration sensor; (b) generating determination data by removing data for the generation period of the electrical noise from vibration data of the monitoring vibration sensor; and (c) determining occurrence of abnormality in the bearing, using the determination data.

### Advantageous Effects of Invention

According to the present invention, electrical noise occurring to the condition monitoring sensor of the condition monitoring device can be removed appropriately without the need to exclude a specific frequency band, so as to reduce errors in abnormality determination.

### BRIEF DESCRIPTION OF DRAWINGS

FIG. 1 is a schematic configuration diagram of a wind turbine to which a condition monitoring device in the present embodiment is applied.

FIG. 2 shows an example of a vibration waveform of measurement data when electrical noise is generated.

FIG. 3 shows a vibration waveform of a comparative example in which a band-pass filter is applied to the measurement data in FIG. 2.

FIG. 4 shows an example of vibration waveforms of measurement data taken by respective condition monitoring sensors when electrical noise is generated in the wind turbine in FIG. 1.

FIG. 5 shows root mean square values of measurement data in a normal state that are taken by respective condition monitoring sensors in the wind turbine in FIG. 1.

FIG. 6 illustrates influence on each condition monitoring sensor in the wind turbine in FIG. 1, when a bearing under monitoring is in an abnormal state.

FIG. 7 is a functional block diagram showing a configuration of a controller in the present embodiment, in terms of functions.

FIG. 8 is a functional block diagram showing functions of a noise removal device in FIG. 7.

FIG. 9 is a functional block diagram showing functions of an abnormality detection device in FIG. 7.

FIG. 10 schematically illustrates a process for removing noise data in the present embodiment.

FIG. 11 is a flowchart for illustrating an abnormality determination process performed by a controller in the present embodiment.

FIG. 12 is a flowchart for illustrating in detail a noise removal process in FIG. 11.

### DESCRIPTION OF EMBODIMENTS

In the following, an embodiment of the present invention is described in detail with reference to the drawings. In the drawings, the same or corresponding parts are denoted by the same reference characters, and a description thereof is not repeated.

Basic Configuration of Condition Monitoring Device

FIG. 1 is a schematic configuration diagram of a wind turbine 10 to which a condition monitoring device for a rolling device is applied according to the present embodiment. Referring to FIG. 1, wind turbine 10 includes a main shaft 20, blades 30, a speed-up gear 40, a power generator 50, a main-shaft bearing 60, vibration sensors 111 to 118 (also referred to collectively as “vibration sensor 110” hereinafter), and a controller 300. Speed-up gear 40, power generator 50, main-shaft bearing 60, vibration sensor 110, and controller 300 are housed in a nacelle 90. Nacelle 90 is supported by a tower 100.

As to the rolling device, devices having parts including contact elements such as bearing and gear are collectively referred to as rolling device. In this wind turbine 10, speed-up gear 40, power generator 50, and main-shaft bearing 60 are the rolling device. For speed-up gear 40, power generator 50, and main-shaft bearing 60, various rolling bearings are used and these devices are lubricated with oil.

Main shaft 20 is connected to an input shaft of speed-up gear 40 in nacelle 90, and supported rotatably by main-shaft bearing 60. Main shaft 20 transmits, to the input shaft of speed-up gear 40, a rotational torque generated by blades 30 receiving wind power. Blades 30 are disposed at the leading end of main shaft 20, converts wind power into a rotational torque, and transmits the rotational torque to main shaft 20.

Speed-up gear 40 is disposed between main shaft 20 and power generator 50 to increase the rotational speed of main shaft 20 and output the resultant rotational speed to power generator 50. In speed-up gear 40, a plurality of rotational shafts and a plurality of bearings (not shown) rotatably supporting these rotational shafts are provided. As bearings for speed-up gear 40 and power generator 50, rolling bearings are used, as in main-shaft bearing 60.

Power generator 50 is connected to an output shaft of speed-up gear 40 for generating electric power from the rotational torque received from speed-up gear 40. Power generator 50 is configured by an induction power generator, for example. A bearing rotatably supporting a rotor is also provided in this power generator 50.

Vibration sensor 110 is a sensor (also referred to as “condition monitoring sensor” hereinafter) for detecting vibration of each bearing in a rolling device in nacelle 90, and secured to a device to be measured. Vibration sensor 110 includes a vibration sensor (main bearing sensor 111) for a bearing in main-shaft bearing 60, vibration sensors (speed-up-gear input bearing sensor 112, speed-up-gear planetary bearing sensor 113, speed-up-gear low speed bearing sensor 114, speed-up-gear middle speed bearing sensor 115, speed-up-gear high speed bearing sensor 116) for bearings in speed-up gear 40, and vibration sensors (generator driving-side bearing sensor 117, generator driven-side bearing sensor 118) for bearings in power generator 50.

Each vibration sensor 110 is an acceleration sensor using a piezoelectric element, for example, and outputs detected vibration data to controller 300. Vibration sensor 110 is not limited to the acceleration sensor. Speed sensor, displacement sensor, AE (Acoustic Emission) sensor, ultrasonic sensor, temperature sensor, acoustic sensor, or the like may also be used as the vibration sensor.

Controller 300 includes a CPU (Central Processing Unit), a storage device, and an input/output buffer for example (they are not shown). Controller 300 receives vibration data detected by vibration sensor 110. Based on a detected value of vibration sensor 110, controller 300 monitors abnormality of a bearing under monitoring, in accordance with a program set in advance.

As to Influence of Electrical Noise on Abnormality Determination

Such a condition monitoring device makes an abnormality determination based on data detected by a plurality of sensors as described above. Signals detected by the sensors, however, may include electrical noise that interferes with condition monitoring. Examples of the factor of generation of sudden electrical noise include transmitted radio waves for radio receivers for example, radio signals, as well as electrostatic discharge from a rotating member, discharge upon opening/closing of electrical contacts of a mechanical switch or relay, glow discharge of a fluorescent lamp, and corona discharge of a high voltage line. When electrical noise is present in detected data, the noise may be determined erroneously to be abnormality in condition monitoring.

FIG. 2 shows an example of vibration data measured by vibration sensor 110 when sudden electrical noise is generated. Regarding FIG. 2, vibration data measured by main bearing sensor 111 is described by way of example. The present embodiment is described in connection with an example where vibration data for 10 seconds is stored at predetermined time intervals, and it is determined based on the stored vibration data whether or not a bearing has abnormality. Other measurement conditions can also be used for the measurement period and the measurement frequency of vibration data.

Referring to FIG. 2, sudden impulsive electrical noise is generated four seconds after the start of measurement. Upon generation of the noise, the vibration acceleration increases instantaneously and thereafter decreases gradually. In a case of determination of occurrence of abnormality in a bearing through frequency analysis, generation of such electrical noise may cause an erroneous determination that the frequency component due to the noise is abnormality, even when abnormality has not occurred actually.

In order to prevent such an erroneous determination, a band-pass filter may be applied to the vibration waveform in FIG. 2 to remove data other than the data on a frequency band (200 to 2000 Hz for example) that can be present due to abnormality of the bearing, as illustrated by a comparative example in FIG. 3, for example. The impulsive data upon the start of electrical noise, however, has all frequency components, and therefore, even if the band-pass filter is used, noise cannot be removed completely under some conditions. Accordingly, the remaining impulsive noise may be determined erroneously to be abnormality.

As described later herein with reference to FIG. 4, depending on the location of the vibration sensor (speed-up gear 40 for example), the vibration level is high even in a normal state. It may be difficult to extract a noise component from the vibration waveform detected by the vibration sensor installed at such a location.

Data detected by these multiple sensors are received through I/O of controller 300. Respective electrical signals from the sensors are usually input by means of a common input/output power supply. Therefore, the sensors are not electrically insulated from each other in most cases. Thus, if an electrical noise is generated in a certain sensor, the other sensors may be influenced by similar electrical noise.

In view of the above, the present embodiment makes use of the fact that influence of electrical noise is common to such multiple sensors which are electrically non-insulated from each other, and employs an approach that removes influence of electrical noise using vibration data measured by a vibration sensor (hereinafter referred to as “reference vibration sensor”) indicating relatively low vibration levels in a normal state (preferably less than or equal to 2.0 m/s²) and installed at a location less prone to be influenced by vibration upon occurrence of abnormality of a bearing under monitoring. More specifically, it is determined, based on vibration data measured by the reference vibration sensor, whether or not electrical noise has been generated. From vibration data of the other vibration sensors, data at the time of the generation of the electrical noise is removed. Then, the corrected vibration data is used to determine whether or not abnormality has occurred.

Such an approach for removing noise data can be used to accurately extract electrical noise from vibration data of the reference vibration sensor without being unable to distinguish electrical noise from vibration in a normal state. Moreover, from the vibration data obtained from respective vibration sensors, data including influence of the electrical noise is removed. Accordingly, errors in determination in condition monitoring can be reduced.

As the reference vibration sensor, a dedicated vibration sensor may be used separately from condition-monitoring vibration sensors for respective bearings. One of condition monitoring sensors, however, may be used to serve as both a condition monitoring sensor and a reference vibration sensor, as long as the sensor meets the condition “indicating relatively low vibration levels in a normal state and less prone to be influenced by vibration when abnormality occurs to a bearing under monitoring.” If a sensor can be used both as a condition monitoring sensor and a reference vibration sensor, no additional sensor is required, which provides minimal increase of the number of parts and reduction of cost.

If a reference vibration sensor is provided separately, it is preferable to use a highly flexible electric wire for example for connecting the reference vibration sensor and use anti-vibration rubber for installing the reference vibration sensor, in order to reduce influence of mechanical vibration of devices.

FIG. 4 shows an example of vibration waveforms of measurement data taken by respective condition monitoring sensors when electrical noise is generated in the wind turbine in FIG. 1. In FIG. 4, FIG. 4 (a) shows a vibration waveform of main bearing sensor 111, and FIG. 4 (b) to FIG. 4 (f) show respective vibration waveforms of input bearing sensor 112, planetary bearing sensor 113, low speed bearing sensor 114, middle speed bearing sensor 115, and high speed bearing sensor 116 for speed-up gear 40, respectively. FIG. 4 (g) and FIG. 4 (h) show respective vibration waveforms of driving-side bearing sensor 117 and driven-side bearing sensor 118 for power generator 50.

The vibration waveforms in FIG. 4 are each a vibration waveform which is exhibited when impulsive electrical noise is generated four seconds after the start of measurement, as in FIG. 2. In each vibration waveform, an impulsive peak is identified, at the point 4 seconds after the start of measurement, in the negative vibration acceleration. However, particularly like FIGS. 4(e), 4(f) and 4(g), in the vibration data measured at a site where the vibration level is high in a normal state, it is difficult to identify a peak in the positive vibration acceleration.

As to Selection of Reference Vibration Sensor

Referring to FIGS. 5 and 6, a description is given of an approach for determining whether or not a condition monitoring sensor can be used as a reference vibration sensor in the present embodiment.

FIG. 5 shows root mean square values (also referred to as “RMS values”) of measurement data in a normal state that are taken by respective condition monitoring sensors in the wind turbine in FIG. 1. It is seen from FIG. 5 that respective RMS values of main bearing sensor 111, speed-up-gear input bearing sensor 112, and speed-up-gear planetary bearing sensor 113 are low. Regarding these sensors, electrical noise can be recognized relatively clearly in FIG. 4.

FIG. 6 shows influence of abnormality of a bearing under monitoring, on each condition monitoring sensor. In FIG. 6, the X axis represents the condition monitoring sensors, the Y axis represents condition monitoring sensors to which abnormality has occurred, and the Z axis represents the rate of change of RMS value.

The rate of change of RMS value is a rate of change of an RMS value (RMS1) of the vibration waveform of a condition monitoring sensor when abnormality occurs to a bearing monitored by another condition monitoring sensor, with respect to an RMS value (RMS2) of the vibration waveform of the former condition monitoring sensor in a normal state. The rate of change of RMS value is defined by the following formula (1).

Rate of change of RMS value=(RMS1−RMS2)/RMS2 (1)

Specifically, FIG. 6 illustrates that the greater the value of the rate of change of RMS value of a condition monitoring sensor, the more likely the influence of abnormality of a bearing monitored by another condition monitoring sensor is exerted on the vibration waveform of the former condition monitoring sensor.

It is seen from FIG. 6 that the rate of change of RMS value of main bearing sensor 111 is less than or equal to 0.1 when a bearing monitored by any of other sensors is in an abnormal state, and thus main bearing sensor 111 is less prone to be influenced by the abnormality of bearings monitored by other sensors. Accordingly, in the description of the present embodiment, main bearing sensor 111 is used as a reference vibration sensor.

In determining whether a condition monitoring sensor can be used as a reference vibration sensor, it is more preferable to use, as a reference vibration sensor, a condition monitoring sensor having a rate of change of RMS value less than or equal to one tenth ( 1/10) of the rate of change of RMS value of a condition monitoring sensor monitoring a bearing to which abnormality has occurred.

As to Noise Removal Process

FIG. 7 is a functional block diagram showing a configuration of controller 300 in the present embodiment in terms of functions. Referring to FIG. 7, controller 300 includes a noise removal device 310, an abnormality detection device 320, and a communication device 330. FIG. 8 is a functional block diagram showing functions of noise removal device 310, and FIG. 9 is a functional block diagram showing functions of abnormality detection device 320.

Referring to FIGS. 7 and 8, noise removal device 310 includes a noise determination device 311, a subtractor 312, and a data acquisition device 313. Noise determination device 311 receives vibration data (reference data) detected by a reference vibration sensor which is one of vibration sensors 110 to determine whether or not electrical noise has been generated and identify the generation period of the electrical noise based on the reference data.

Data acquisition device 313 receives vibration data (monitoring data) detected by each vibration sensor 110. Subtractor 312 removes, from the vibration data of each vibration sensor 110 obtained from data acquisition device 313, data for the generation period of the electrical noise identified by noise determination device 311, and outputs the resultant data as determination data to abnormality detection device 320.

Referring to FIGS. 7 and 9, abnormality detection device 320 includes high-pass filters (also referred to as “HPF” hereinafter) 321, 324, RMS value calculators 322, 325, an envelope processing device 323, a storage device 326, and a diagnosis device 327.

HPF 321 receives the vibration data (determination data) from which electrical noise has been removed by noise removal device 310. HPF 321 passes signal components, of the determination data, higher than a predetermined frequency to remove low frequency components. This HPF 321 is provided for removing a DC component included in the vibration waveform of the determination data. HPF 321 may not be provided if the determination data does not include the DC component.

RMS value calculator 322 receives, from HPF 321, the vibration waveform of the determination data from which the DC component has been removed. RMS value calculator 322 calculates the root mean square value (RMS value) of the vibration waveform and outputs the calculated RMS value to storage device 326.

Envelope processing device 323 receives the determination data from noise removal device 310. Envelope processing device 323 performs envelope processing on the determination data to generate an envelope waveform of the vibration waveform of the determination data. To the envelope processing performed by envelope processing device 323, any of a variety of known approaches is applicable. By way of example, the vibration waveform is rectified into an absolute-value vibration waveform and passed through a low-pass filter (LPF) to thereby generate an envelope waveform of the vibration waveform.

HPF 324 receives, from envelope processing device 323, the determination data having been subjected to the envelope processing HPF 324 passes signal components of the determination data that are higher than a predetermined frequency to remove low frequency components. This HPF 324 removes the DC component included in the envelope waveform to extract the AC component of the envelope waveform.

RMS value calculator 325 receives the AC component of the envelope waveform from HPF 324. Then, RMS value calculator 325 calculates the root mean square value (RMS value) of the AC component of the envelope waveform and outputs the resultant value to storage device 326.

Storage device 326 successively stores the RMS value of the vibration waveform of the determination data calculated by RMS value calculator 322 and the RMS value of the AC component of the envelope waveform calculated by RMS value calculator 325, so that the RMS values are synchronized with each other. Storage device 326 is configured for example by a readable/writable nonvolatile memory.

Diagnosis device 327 reads, from storage device 326, the RMS value of the determination data and the RMS value of the AC component of the envelope waveform to diagnose abnormality of each bearing, based on the two RMS values. More specifically, diagnosis device 327 diagnoses abnormality of each bearing, based on change, with time, of the RMS value of the determination data and the RMS value of the AC component of the envelope waveform.

FIG. 10 schematically illustrates a noise data removal process performed by noise removal device 310 in FIGS. 7 and 8 in the present embodiment. FIG. 10 shows a vibration waveform of main bearing sensor 111 used as a reference vibration sensor.

Referring to FIG. 10, noise removal device 310 initially subtracts, from vibration data, an average value of vibration data for a predetermined period (10 seconds in FIG. 10) obtained from the reference vibration sensor for this predetermined period, to thereby generate calculation data from which influence of drift has been removed.

Next, noise removal device 310 divides the calculation data into N segments at predetermined time intervals. In the example in FIG. 10, the predetermined time interval is 0.1 second and N=100.

Then, noise removal device 310 generates (N−M+1) group segments from the obtained 100 segments (SEG1-SEG100). Each of the group segments is made up of any M consecutive segments (M<N). In the example in FIG. 10, M=30 and 71 group segments (GS1-GS71) are generated. In group segments adjacent to each other (e.g., GS1 (SEG1-SEG30) and GS2 (SEG2-SEG31)), 29 segments in one group segment overlap segments in the adjacent group segment.

Subsequently, noise removal device 310 determines calculation data having the maximum absolute value, among calculation data included in respective group segments, and identifies the determined calculation data as having a maximum absolute value among the group segments.

Noise removal device 310 also calculates the root mean square value (RMS value) of the calculation data in each segment, and determines the average value of p (p<M, p=10, for example) RMS values in ascending order from the smallest one, out of the obtained N RMS values so as to use the average value as an average RMS value. The average RMS value corresponds to the RMS value of the state without noise in the calculation data.

Then, noise removal device 310 identifies a group segment having the maximum absolute value that is at least ten times as large as the average RMS value, as “noise-generated segment” including influence of electrical noise. Noise removal device 310 generates, from the original vibration data of each condition monitoring sensor, the determination data by removing data for the period corresponding to the group segment identified as the noise-generated segment.

For the determination data, such processing is performed to eliminate the data including influence of electrical noise. The resultant determination data can be used to perform an abnormality detection process to prevent erroneous determination due to electrical noise in detecting abnormality.

The division into group segments is intended to reliably remove attenuated portions of the vibration waveform due to electrical noise. The predetermined period and the specific values for N, M. and p for the above-described process are given by way of example, and can be set appropriately depending on the application.

FIGS. 11 and 12 are flowcharts for illustrating an abnormality determination process performed by controller 300 in the present embodiment.

Referring to FIG. 11, in step (abbreviated as S hereinafter) 100, controller 300 acquires vibration data from each of vibration sensors (condition monitoring sensors and reference vibration sensor) for a predetermined period and stores the vibration data in controller 300.

Next, in S200, controller 300 identifies a generation period of electrical noise based on the vibration data from the reference vibration sensor, as described above with reference to FIG. 10. Then, controller 300 removes, from each condition monitoring sensor, the data for the generation period of the electrical noise to thereby generate determination data.

Details of the noise removal process in S200 are now described with reference to FIG. 12. Referring to FIG. 12, in S210, controller 300 calculates average value Xa of the whole vibration data obtained from the reference vibration sensor, and subtracts this average value Xa from each data X to generate calculation data. The operation in S210 can remove the DC component (drift) in the vibration data.

Next, in S220, controller 300 divides the calculation data into segments (SEG) and groups the segments into group segments (GS), as described above with reference to FIG. 10. Then, controller 300 calculates the maximum absolute value (MAXabs) of each group segment (S230) and calculates the root mean square value (RMSs) of the group segment (S240). In S250, controller 300 calculates the average root mean square value (RMSa) which is the average value of 10 RMS values in ascending order from the smallest one, as an average value of vibration data in a normal state.

In S260, controller 300 extracts, as a noise-generated segment, a group segment having the maximum absolute value MAXabs that is at least 10 times as large as the average RMS value RMSa. In S270, controller 300 removes, from the vibration data obtained from each condition monitoring sensor, the data for the period corresponding to the noise-generated segment extracted in S260 to generate determination data. Such a process can be performed to generate data without influence of electrical noise, or with reduced influence of electrical noise.

Referring again to FIG. 11, in S300, controller 300 performs the abnormality determination process by abnormality detection device 320, using the determination data generated in S200 to determine whether or not abnormality has occurred to a bearing under monitoring. As a specific abnormality determination approach, any of known determination techniques can be used.

Control can be performed following the above described process to determine occurrence of abnormality, using data with reduced influence of electrical noise, and therefore, errors in determination that may be generated due to electrical noise can be reduced. Moreover, because the noise removal process does not include the process of extracting only a specific frequency band by a band-pass filter or the like, monitoring can be performed without excluding a certain frequency band. Accordingly, this process can be applied as well to facilities that require monitoring of a wide frequency band.

The above description is given of the determination of abnormality of a bearing in the wind turbine. The abnormality determination process in the present embodiment, however, is also applicable to facilities other than the wind turbine, as long as the wind turbine has a rolling device including bearing(s).

It should be construed that embodiments disclosed herein are given by way of illustration in all respects, not by way of limitation. It is intended that the scope of the present invention is defined by claims, not by the description above, and encompasses all modifications and variations equivalent in meaning and scope to the claims.

### REFERENCE SIGNS LIST

10 wind turbine; 20 main shaft, 30 blade; 40 speed-up gear; 50 power generator; 60 main-shaft bearing; 90 nacelle; 100 tower; 110-118 vibration sensor; 300 controller; 310 noise removal device; 311 noise determination device; 312 subtractor; 313 data acquisition device; 320 abnormality detection device; 322, 325 RMS value calculator; 323 envelope processing device; 326 storage device; 327 diagnosis device; 330 communication device

1. A condition monitoring device for a rolling device including a first bearing, the condition monitoring device comprising:
a monitoring vibration sensor configured to detect vibration of the first bearing;
a reference vibration sensor electrically non-insulated from the monitoring vibration sensor and disposed at a location less influenced by vibration generated in occurrence of abnormality in the first bearing; and
a controller configured to monitor abnormality of the first bearing based on vibration data detected by the monitoring vibration sensor,
the controller being configured to
identify a generation period of electrical noise based on a detected value of the reference vibration sensor,
generate determination data by removing data for the generation period of electrical noise from the vibration data of the monitoring vibration sensor, and
determine occurrence of abnormality in the first bearing, using the determination data.

2. The condition monitoring device according to claim 1, wherein the reference vibration sensor is disposed at a location where a vibration level is less than or equal to 2 m/s² in a state where no abnormality occurs to the first bearing.

3. The condition monitoring device according to claim 1, wherein
the rolling device further includes a second bearing, and
the reference vibration sensor is a sensor configured to detect vibration of the second bearing.

4. The condition monitoring device according to claim 1, wherein
the controller is configured to
generate calculation data by subtracting, from vibration data of the reference vibration sensor detected for a predetermined period, an average value of the vibration data for the predetermined period,
divide the calculation data into N segments at predetermined time intervals,
generate (N−M+1) group segments from the N segments, each of the group segments being made up of any M (M<N) consecutive segments in the N segments,
determine calculation data included in a group segment and having a maximum absolute value among calculation data included in respective group segments,
calculate respective RMS values of the calculation data of respective segments, and calculate an average RMS value by averaging respective RMS values of p (p<M) pieces of data in ascending order from a piece of data having a smallest RMS value,
identify a group segment having the maximum absolute value at least 10 times as large as the average RMS value, as a noise-generated segment including influence of electrical noise, and
generate the determination data by removing, from vibration data of the reference vibration sensor, data for a period corresponding to the noise-generated segment.

5. A condition monitoring device for a rolling device including a plurality of bearings, the condition monitoring device comprising:
a plurality of vibration sensors each provided for a corresponding bearing among the plurality of bearings, the plurality of vibration sensors each being configured to detect vibration of the corresponding bearing; and
a controller configured to monitor abnormality of the plurality of bearings based on respective vibration data detected by the plurality of vibration sensors,
the plurality of vibration sensors being electrically non-insulated from each other,
the controller being configured to
select one of the plurality of vibration sensors as a reference vibration sensor,
identify a generation period of electrical noise based on a detected value of the reference vibration sensor,
generate, for each vibration sensor of the plurality of vibration sensors, determination data by removing data for the generation period of electrical noise from vibration data detected by the each vibration sensor, and
determine occurrence of abnormality in the bearing for which the each vibration sensor is provided, using the determination data.

6. The condition monitoring device according to claim 5, wherein
the controller is configured to
calculate, for each of the plurality of vibration sensors, a rate of change of an RMS value of the detected vibration data in an abnormal state with respect to an RMS value of the detected vibration data in a normal state, and
select, as the reference vibration sensor, a vibration sensor having the rate of change of the RMS value less than or equal to one tenth of the rate of change of the RMS value of a vibration sensor for a bearing to which abnormality occurs.

7. A wind turbine comprising a condition monitoring device according to claim 1.

8. A method for removing electrical noise from a monitoring vibration sensor of a condition monitoring device for a rolling device including a bearing, the condition monitoring device comprising the monitoring vibration sensor configured to detect vibration of the bearing, the condition monitoring device further comprising a reference vibration sensor electrically non-insulated from the monitoring vibration sensor and less influenced by vibration generated in occurrence of abnormality in the bearing, the method comprising:
identifying a generation period of electrical noise based on a detected value of the reference vibration sensor;
generating determination data by removing data for the generation period of electrical noise from vibration data of the monitoring vibration sensor; and
determining occurrence of abnormality in the bearing, using the determination data.

9. The condition monitoring device according to claim 2, wherein
the rolling device further includes a second bearing, and
the reference vibration sensor is a sensor configured to detect vibration of the second bearing.

10. The condition monitoring device according to claim 2, wherein
the controller is configured to
generate calculation data by subtracting, from vibration data of the reference vibration sensor detected for a predetermined period, an average value of the vibration data for the predetermined period,
divide the calculation data into N segments at predetermined time intervals,
generate (N−M+1) group segments from the N segments, each of the group segments being made up of any M (M<N) consecutive segments in the N segments,
determine calculation data included in a group segment and having a maximum absolute value among calculation data included in respective group segments,
calculate respective RMS values of the calculation data of respective segments, and calculate an average RMS value by averaging respective RMS values of p (p<M) pieces of data in ascending order from a piece of data having a smallest RMS value,
identify a group segment having the maximum absolute value at least 10 times as large as the average RMS value, as a noise-generated segment including influence of electrical noise, and
generate the determination data by removing, from vibration data of the reference vibration sensor, data for a period corresponding to the noise-generated segment.

11. The condition monitoring device according to claim 3, wherein
the controller is configured to
generate calculation data by subtracting, from vibration data of the reference vibration sensor detected for a predetermined period, an average value of the vibration data for the predetermined period,
divide the calculation data into N segments at predetermined time intervals,
generate (N−M+1) group segments from the N segments, each of the group segments being made up of any M (M<N) consecutive segments in the N segments,
determine calculation data included in a group segment and having a maximum absolute value among calculation data included in respective group segments,
calculate respective RMS values of the calculation data of respective segments, and calculate an average RMS value by averaging respective RMS values of p (p<M) pieces of data in ascending order from a piece of data having a smallest RMS value,
identify a group segment having the maximum absolute value at least 10 times as large as the average RMS value, as a noise-generated segment including influence of electrical noise, and
generate the determination data by removing, from vibration data of the reference vibration sensor, data for a period corresponding to the noise-generated segment.

12. A wind turbine comprising a condition monitoring device according to claim 2.

13. A wind turbine comprising a condition monitoring device according to claim 3.

14. A wind turbine comprising a condition monitoring device according to claim 4.

15. A wind turbine comprising a condition monitoring device according to claim 5.

16. A wind turbine comprising a condition monitoring device according to claim 6.
